(19) United States
(12) Patent Application Publication
(10) Pub. No.: US 2014/0352918 A1
(43) Pub. Date: Dec. 4, 2014

(54) TEMPERATURE CONTROLLED HABITAT

(71) Applicant: Gordon Iain Priestly, Stirling (GB)

(72) Inventor: Gordon Iain Priestly, Stirling (GB)

(73) Assignee: SAFEHOUSE HABITATS (SCOTLAND) LIMITED, Dundee (GB)

(21) Appl. No.: 14/345,229

(22) PCT Filed: Sep. 5, 2012
(86) PCT No.: PCT/GB2012/000698

§ 371 Date: Aug. 21, 2014

(30) Foreign Application Priority Data
Sep. 16, 2011 (GB) 1116052.0

(51) Int. Cl. B23K 37/00; F24F 5/00

(52) U.S. Cl. CPC B23K 37/00; F24F 5/0085
USPC 165/57; 454/238; 454/251; 165/47; 62/259.1

(57) ABSTRACT

Disclosed is a habitat assembly comprising a habitat structure for undertaking hot work. Air is supplied to the habitat by an air supply system, through a conduit. The air supply system comprises a fan or blower. Means for altering the temperature or humidity of the air supplied to habitat is positioned down stream of the fan or blower. The fan or blower both creates and maintain an overpressure within the habitat structure and pumps air through the means for altering the temperature or humidity. The means for altering temperature may comprise a heater and/or an air conditioning unit. Also disclosed in an air conditioning unit for a habitat assembly, adapted to facilitate emergency shut down.

The present invention relates to a habitat, sometimes referred to as a welding enclosure, for undertaking hot work, and in particular a temperature controlled habitat.

When undertaking hot work (for example, grinding, welding and the like) in an environment where flammable gases may be present, for example in oil and gas production or exploration environments (zone 1 and 2 hazardous areas) it has become established practice to utilise a habitat (welding enclosure) for undertaking such hot work, as well as activities which are not classified as hot work—for example cable joining, sand blasting and the application of passive fire protection to structures.

A habitat comprises an enclosed structure which is built around the item of work on which hot work is to be undertaken and a positive air pressure is then applied inside the habitat so as to prevent the ingress of flammable gases and thereby to provide a safe environment for undertaking hot work activities.

Welding habitats have been known for many years and early versions comprised more or less a rigid structure built from wood panels and sheet metal, however, such structures are difficult and time consuming to erect and dismantle and the applicant was one of the pioneers to develop flexible welding/hot work habitats of modular form which can be readily erected and dismantled on site.

Oil and/or gas production or exploration is undertaken in many geographical areas around the world including equatorial areas where ambient temperatures can be well in excess of 30° C. It will be appreciated that when undertaking hot work, in particular welding within a habitat situated in such geographical location with high ambient temperatures that the temperature within the habitat can reach extremely high temperatures in the range of 30° C. to 50° C. or more in extreme situations such that the habitat can become so hot as to make it unsuitable for operatives to work. On the other hand oil and/or gas production or exploration can take place in cold environments such as arctic regions of Canada and Siberia where ambient air temperatures can be many many degrees below 0° C., for example −20 to −40° C. It will therefore be appreciated that the air supplied into a habitat to create the working overpressure can result in the operating temperature within the habitat being close to the ambient air temperature which again causes problems for operatives. Furthermore high air humidity can be a problem in some locations which can result in operating difficulties for operatives.

It is an object of the present invention to avoid or minimise one or more of the foregoing disadvantages.

Accordingly, the present invention provides a habitat (or welding enclosure) assembly comprising a habitat structure formed and arranged to allow hot work to be undertaken; a conduit to supply fresh air to the habitat; a habitat air supply system comprising a fan or blower; and means for altering the temperature of the air supplied to said habitat through the conduit by said air supply system; the means for altering the temperature of the air connected to the air supply system by the conduit positioned down stream of the fan or blower; the fan or blower is formed and arranged to create and maintain an overpressure within the habitat structure and to pump air through the means for altering the temperature of the air. In use, the temperature within the habitat may be controlled according to operational requirements.

In another respect the present invention provides a humidity controlled habitat (or welding enclosure) assembly comprising a habitat structure formed and arranged to allow hot work to be undertaken; a habitat air supply system formed and arranged to create and maintain an overpressure within said habitat structure; and means for altering the humidity of the air supplied to said habitat by said air supply system, whereby in use the humidity within the habitat may be controlled according to operational requirements.

Thus, with a temperature and/or humidity controlled habitat according to the present invention it is possible to control the temperature and/or humidity of the working environment within the habitat regardless of the ambient external temperature or humidity.

Preferably, for use in hot working environments, the means for altering the temperature of the air supplied to the habitat is in the form of an air conditioning (cooling) unit of the type suitable for use in zones 1 and 2 hazardous areas. As the habitat air supply system comprises a blower to supply air from an area where there is little or no possibility of flammable gas being drawn into the air supply to the habitat, the air conditioning unit for use with the invention does not require any fan assembly and thus air is blown through the conditioning unit by the habitat air supply system. Typically an air conditioning unit will have a fan or blower on its cooling (evaporator) side but for use in the present invention this is unacceptable insofar as in the event of failure or shutdown of the habitat, for example, as a result of gas being detected in and around the habitat or the over pressure in the habitat falling below preset value, the habitat pressurisation is not compromised as movement of the air is controlled externally.

Typically with the air supply system to a habitat there is included a gas monitoring system formed and arranged to monitor the air being supplied to the habitat. The gas monitoring system is formed and arranged to close off the air supply to the habitat in the event that the gas detector situated in the conduit that is supplying air to the habitat detects flammable gas or any other gas which may present a safety hazard, such as hydrocarbons or hydrofluorocarbons. Typically an air conditioning unit of the type for use in the present invention contains a hydrofluorocarbon refrigerant and thus desirably the air conditioning unit should be positioned up stream from the gas monitoring system such that gas monitoring system can monitor for any breach of containment from the AC unit.

The air supply system may comprise a fan or blower for blowing air into the habitat. Preferably the fan or blower is located towards the safe area from which air is being extracted such that in the event of the gas monitoring system detecting gas, the air supply system can be shutdown thereby limiting the amount of potential flammable/hydrocarbon gases entering the system.

The fan, means for altering temperature (e.g. air conditioning unit) and the gas monitoring system and the habitat are all connected together by a conduit that supplies the air to the habitat. The air supply system may further comprise a fire damper positioned in the conduit. The air supply system may be shut down by shutting down the fan, and/or by closing the damper positioned in the conduit.

The damper is preferably positioned at or near the end of the conduit connected to the habitat. Thus, if a hazardous gas is detected, the damper can be closed before a hazardous amount of the hazardous gas enters the habitat.

Ideally the distance between the air conditioning unit or other means for altering temperature and the habitat should be minimized such that the length of the conduit/ducting between the habit and the air conditioning unit is minimized to avoid heat exchange (i.e. heat loss/gain). Desirably there may be provided means for insulating the conduit/ducting between the air conditioning unit and the habitat so as to minimize any heat exchange (loss/gain)as the air passes from the means for altering temperature (e.g. an air conditioning unit or heater) to the habitat. Desirably there is provided means for insulating thermally any of the fan, the air supply system, the gas monitoring system and the habitat itself.

Typical air conditioning units are controlled/regulated by adjusting the fan speed but as noted above the air conditioning unit used for the present invention does not include a fan. Accordingly the air conditioning unit for use in the present invention is controlled by cycling the refrigerant compressor on and/or off as required.

Accordingly in the event that the gas monitoring system identifies the presence of dangerous/flammable/hydrocarbon gases in the air supply to the habitat, the gas monitoring system can shutdown the air conditioning unit and simultaneously shut down the air supply to the habitat.

This means that a typical air conditioning unit is not suitable for use with the present invention as typical air conditioning units run a shutdown sequence on power off where all of the refrigerant is pumped into the AC unit reservoir to prevent the refrigerant compressor flooding or not restarting and/or potentially damaging/breaking the compressor. It will be appreciated that in the event of an immediate power down as a result of gas detection a standard/typical air conditioning unit would not be suitable. Accordingly the present invention also provides an air conditioning unit provided with valves, typically solenoid operated valves, which are included around the refrigerant loop to ensure that upon an immediate power down the liquid and gas sides of the refrigerant loop are isolated. This may be achieved by mounting a solenoid valve, specifically an ex rated solenoid valve adjacent to and upstream of the expansion valve to shut off the line carrying refrigerant into the evaporator in the event of an emergency shutdown or a power interruption thereby protecting the compressor from damage when restarted which can happen if there is a build up of liquid refrigerant in the suction line of the compressor. The solenoid valve limits the amount of vapour in the suction line which can condense out into liquid and thereby prevents compressor “hammer” and associated potential damage on restart. An additional valve, again an ex rated solenoid valve can be positioned in the line after the evaporator and directly adjacent to the compressor to further limit the volume of vapour for condensation when shutdown occurs.

Preferably temperature control is achieved by means of a temperature sensing probe located inside the habitat and connected to the means for controlling temperature (e.g. an air conditioning unit or heater). For example, the desired temperature level within the habitat may be selected between a plurality of predetermined levels by means of a selection switch or selector mounted on the air conditioning unit or within the habitat such the operators operating within the habitat can adjust the temperature to a desired operating level.

As noted above there may be particular operational requirements where the outside ambient temperature of air is very low such that it requires the temperature of air being supplied to the habitat to be raised at a comfortable operational level. In these circumstances instead of utilising an air conditioning unit to cool the air there may be used a heater of the type suitable for use in hazardous locations. Similar control systems to those mentioned above for use of an air conditioning unit may be used for the heater.

Temperature control is further achieved by the use of suitable insulation of the panels that constitute the habitat structure thus preferably there are used thermally insulated panels of the type used for the modular construction of habitats. Preferably there is used a panel comprising a first layer of flame retardant PVC sandwiching a foil insulation layer with a second layer of flame retardant PVC. Typically there may be used a PVC layer having one side silver and the other side black such that one side reflects thermal radiation whereas the black side absorbs it. Thus the panels may be mounted either to absorb or reflect sunlight (or other thermal radiation) according to operational requirements.

Further preferred features and advantages of the present invention will appear in the following detailed description given by way of an example of a preferred embodiment illustrated with reference to the accompanying drawing in which:

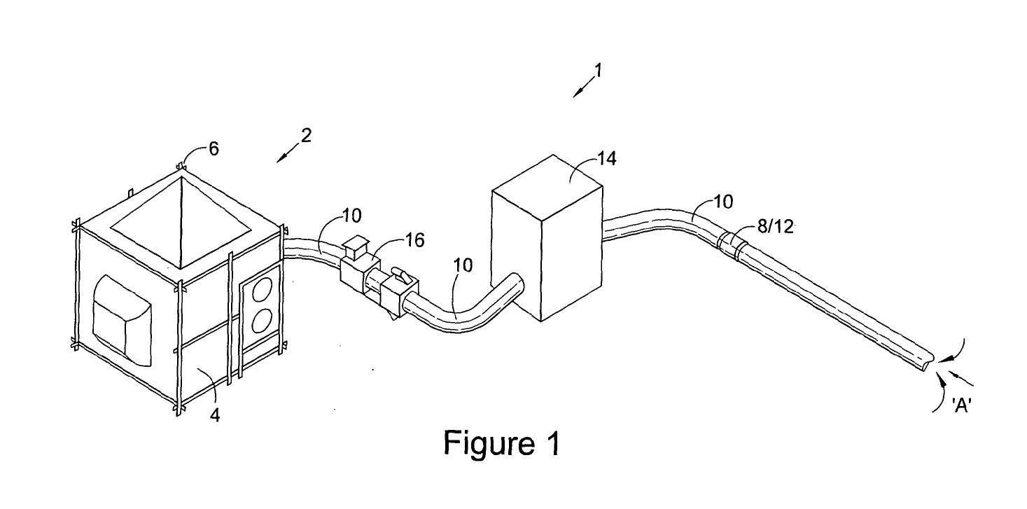

FIG. 1 is a schematic layout of a temperature controlled habitat according to the present invention.

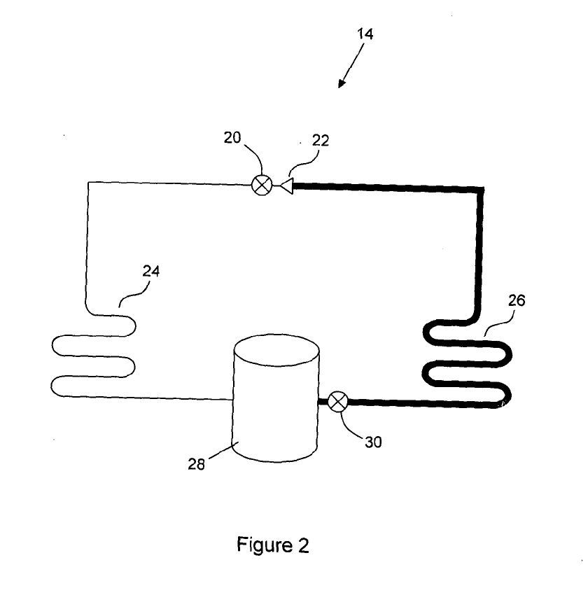

FIG. 2 is a schematic layout of an air conditioning unit for use with a temperature controlled habitat.

A temperature controlled habitat assembly, generally indicated by reference number 1 is shown in FIG. 1. The habitat assembly comprises a habitat structure (2) which comprises a plurality of interconnected panels (4) within a framework (6) so as to provide an enclosure within which hot work, such as welding, may be undertaking.

The assembly (1) is provided with a habitat air supply system (8) formed and arranged to create and maintain an overpressure within the habitat structure (2) such that any explosive gases around the habitat may not penetrate into the habitat and be potentially ignited by an ignition source within the habitat structure. The air is supplied to the habitat along ducting (10) with the air being picked up from an area “A” remote from the habitat where it is known that there are no potentially explosive gases. The air is pumped through the ducting (10) by a fan (12). The fan pumps clean fresh air through an air conditioning unit (14) where the air is cooled. It is then passed further along the ducting to a gas sensing monitor (16) which it then passes through into the habitat (2). The AC unit also reduces humidity of air entering the habitat. Means for draining water which condenses on the AC unit in use may also be provided (not shown).

The gas sensing module (16) monitors for any hydrocarbons or explosive gases passing into the habitat and is formed and arranged to close down the operation of the fan (12) or to operate a damper (not shown) within the ducting so as to block the flow of air to the habitat.

A temperature sensor, not shown, is mounted within the habitat for measuring the internal habitat enclosure temperature and the sensor is connected to the air conditioning unit. An operator in the habitat structure may select a predetermined temperature using a switch mounted on the air conditioning unit. The air conditioning unit is then controlled by cycling the compressor on and off as required whilst the fan blows fresh clean air through air conditioning unit and the gas sensing module into the habitat. Insulation, not shown, may be provided between the air conditioning unit and the habitat to minimize any loss of cooling temperature of the air as it passes through the ducting.

For use in the types of environments where habitats are used, all equipment must be suitably certified for safe use in zone 1 and 2 areas.

In more detail the AC unit, shown in FIG. 2, has an ex rated solenoid valve (20) adjacent to and upstream of the expansion valve (22) to shut off the line carrying the refrigerant from the condenser (24) into the evaporator (26) in the event of an emergency shutdown or power interruptions thereby protecting the compressor (28) against damage when we started due to the build up of liquid refrigerant in the suction line to the compressor. The solenoid valve limits the amount of vapour in the suction line which can condense out into liquid thereby preventing compressor “hammer” and associated potential damage on restart. An additional solenoid valve 30 is positioned in the line after the evaporator and directly adjacent to the compressor to further limit the volume of vapour or condensation when shutdown occurs.

An air conditioning unit having the aforesaid features is available from Safe-ex Ltd of Bedford, UK.

Where it is required to raise the temperature of air being supplied into the habitat, where the habitat is being used in a cold working environment the air conditioning unit is in the form of a heater. Heaters are the type suitable for use in zone 1 and 2 hazardous locations are available from CCI Thermal Technologies, Inc or ex Service PTE Ltd.

Various modifications may be made to the above described embodiment without departing from the scope of the present invention. For example, the habitat assembly described with either an air conditioning (cooling) system or with a heater system may be integrated with the applicant's control system described in its UK Patent No. GB2465285, the content of which is included herein by reference.

1. A habitat assembly comprising:
a habitat structure formed and arranged to allow hot work to be undertaken;
a conduit to supply fresh air to the habitat structure;
a habitat air supply system comprising a fan or blower; and
means for altering the temperature of the air supplied to said habitat structure through the conduit by said air supply system;
the means for altering the temperature of the air being connected to the air supply system by the conduit and positioned down stream of the fan or blower;
the fan or blower being formed and arranged to create and maintain an overpressure within the habitat structure and to pump air through the means for altering the temperature of the air.

2. A habitat assembly according to claim 1, wherein the length of conduit between the means for altering temperature and the habitat structure is minimized.

3. A habitat assembly according to claim 1, wherein the air supply system has a gas monitoring system formed and arranged to close off the air supply to the habitat structure in the event that a gas detector, situated in the conduit, detects flammable gas or other hydrocarbons in the conduit.

4. A habitat assembly according to claim 3, wherein the means for altering the temperature of the air is positioned up stream from the gas monitoring system.

5. A habitat assembly according to claim 3, comprising a damper within the conduit and wherein the gas monitoring system is configured to operate the damper so as to close off the air supply to the habitat structure.

6. A habitat assembly according to claim 5, wherein the damper is positioned down stream from the gas monitoring system.

7. A habitat assembly comprising:
a habitat structure formed and arranged to allow hot work to be undertaken;
a habitat air supply system formed and arranged to create and maintain an overpressure within said habitat structure; and
means for altering the humidity of the air supplied to said habitat by said air supply system, whereby in use the humidity within the habitat may be controlled according to operational requirements.

8. A habitat assembly according to claim 1, wherein the habitat structure is made of modular panels.

9. A habitat assembly as claimed in claim 8, wherein the modular panels are thermally insulated.

10. A habitat assembly according to claim 1, wherein the conduit is insulated.

11. A habitat assembly according to claim 1, wherein the means for altering the temperature of the air supplied to the habitat structure is in the form of an air conditioning unit.

12. A habitat assembly according to claim 11, wherein the air conditioning unit includes a refrigerant loop, an expansion valve and has solenoid operated valves included around the refrigerant loop, wherein one solenoid valve is an ex rated solenoid valve mounted adjacent to and upstream of the expansion valve.

13. A habitat assembly according to claim 1, comprising an air conditioning unit for altering the temperature of air supplied to the habitat structure, the air conditioning unit comprising;
a refrigerant loop having an evaporator and a condenser;
an expansion valve positioned in the refrigerant loop upstream of the evaporator and downstream of the condenser;
a compressor positioned in the refrigerant loop downstream of the evaporator and upstream of the condenser; and
a solenoid valve positioned in the refrigerant loop adjacent to and upstream of the expansion valve, operable to shut off the line carrying refrigerant from the condenser to the evaporator in the event of an emergency shutdown or a power interruption.

14. A habitat assembly according to claim 13, wherein the air conditioning unit further comprises a solenoid valve positioned in the refrigerant loop downstream of the evaporator and adjacent to the compressor, operable to shut off the line carrying refrigerant from the evaporator to the condenser in the event of an emergency shutdown or a power interruption.

15. An air conditioning unit for a habitat assembly according to claim 1, comprising:
a refrigerant loop having an evaporator and a condenser;
comprising an expansion valve positioned in the refrigerant loop upstream of the evaporator and downstream of the condenser;
a compressor positioned in the refrigerant loop downstream of the evaporator and upstream of the condenser; and
a solenoid valve positioned in the refrigerant loop adjacent to and upstream of the expansion valve, operable to shut off the line carrying refrigerant from the condenser to the evaporator in the event of an emergency shutdown or a power interruption.
